(19) United States
(12) Patent Application Publication
(10) Pub. No.: US 2025/0128665 A1
(43) Pub. Date: Apr. 24, 2025

(54) IN-VEHICLE DEVICE ATTACHMENT STRUCTURE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Masami ONO, Osaka (JP); Kosuke SONE, Osaka (JP); Tatsumi SATO, Mie (JP); Tomoka SHIDA, Osaka (JP)

(21) Appl. No.: 18/685,490

(22) PCT Filed: Aug. 25, 2022
(86) PCT No.: PCT/JP2022/032033

§ 371 Date: Feb. 21, 2024

(30) Foreign Application Priority Data
Sep. 9, 2021 (JP) 2021-146755

(51) Int. Cl. B60R 11/00

(52) U.S. Cl. CPC B60R 11/00; B60R 2011/0028; B60R 2011/0064

(57) ABSTRACT

An object is to provide a technique that makes it easy to retrofit a device to a vehicle. An in-vehicle device attachment structure includes a retrofit device attachment portion provided in a vehicle, an intermediate base plate attached to the retrofit device attachment portion, and a retrofit device attached to the intermediate base plate.

### TECHNICAL FIELD

The present disclosure relates to an in-vehicle device attachment structure.

### BACKGROUND

Patent Document 1 discloses a wire harness assembly to be disposed between a ceiling and a roof liner of a vehicle. In the wire harness assembly disclosed in Patent Document 1, a wire harness for a device to be disposed on the ceiling is disposed between a sound insulating member and a protection material.

### PRIOR ART DOCUMENT

### Patent Document

Patent Document 1: JP 2018-090229 A

### SUMMARY OF THE INVENTION

### Problems to be Solved

It is desired that devices can be easily retrofitted to vehicles.

In view of this, an object is to provide a technique that makes it easier to retrofit a device to a vehicle.

### Means to Solve the Problem

An in-vehicle device attachment structure according to the present disclosure is an in-vehicle device attachment structure comprising a retrofit device attachment portion provided in a vehicle, an intermediate base plate attached to the retrofit device attachment portion, and a retrofit device attached to the intermediate base plate.

### Effect of the Invention

According to the present disclosure, a device can be retrofitted to a vehicle easier.

### BRIEF DESCRIPTION OF THE DRAWINGS

FIG. 1 is a schematic perspective view showing an example of a vehicle to which an in-vehicle device attachment structure is mounted.

FIG. 2 is a diagram showing a position at which the in-vehicle device attachment structure is mounted in a vehicle.

FIG. 3 is a schematic perspective view showing an in-vehicle device attachment structure according to a first embodiment.

FIG. 4 is a schematic bottom view showing the in-vehicle device attachment structure according to the first embodiment.

FIG. 5 is a schematic front view showing the in-vehicle device attachment structure according to the first embodiment.

FIG. 6 is an exploded perspective view of the in-vehicle device attachment structure.

FIG. 7 is an exploded bottom view of an intermediate base plate and retrofit devices.

FIG. 8 is a diagram showing a method for retrofitting the retrofit device.

FIG. 9 is a schematic front view showing an in-vehicle device attachment structure according to a second embodiment.

FIG. 10 is a schematic front view showing an in-vehicle device attachment structure according to a third embodiment.

### DETAILED DESCRIPTION TO EXECUTE THE INVENTION

### Description of Embodiments of Disclosure

First, embodiments of the present disclosure will be listed and described.

An in-vehicle device attachment structure according to the present disclosure is as follows.

(1) Provided is an in-vehicle device attachment structure comprising a retrofit device attachment portion provided in a vehicle, an intermediate base plate attached to the retrofit device attachment portion, and a retrofit device attached to the intermediate base plate. According to the in-vehicle device attachment structure with the above configuration, the retrofit device is attached to the vehicle via the intermediate base plate. Due to the attachment structures for the intermediate base plate and the retrofit device attachment portion being standardized, and an attachment structure that conforms to the retrofit device being adopted for the intermediate base plate, there is no need to provide an attachment structure that corresponds to the retrofit device to the vehicle, and various types of devices can be easily retrofitted.

(2) In the in-vehicle device attachment structure of (1), a configuration is also possible in which the retrofit device attachment portion includes a first rail that supports one lateral side of the intermediate base plate and a second rail that supports another lateral side of the intermediate base plate. With this configuration, the intermediate base plate can slide to the attachment position along the first rail and the second rail.

(3) In the in-vehicle device attachment structure of (2), a configuration is also possible in which the first rail is longer than the second rail. With this configuration, when the intermediate base plate is supported by the first rail and the second rail, the intermediate base plate can slide while the one lateral side of the intermediate base plate is supported at the position of the first rail that extend beyond the second rail, and as a result of that, the other lateral side of the intermediate base plate can also be supported by the second rail. With this configuration, work for placing the intermediate base plate so as to be supported by the first rail and the second rail can be more easily performed.

(4) In the in-vehicle device attachment structure of (2) or (3), a configuration is also possible in which the retrofit device attachment portion includes a plurality of base plate attachment portions provided at a plurality of positions spaced apart from each other along a longitudinal direction of the first rail and the second rail, and the intermediate base plate is attached to one of the plurality of base plate attachment portions. With this configuration, the degree of freedom in the attachment position of the intermediate base plate in the longitudinal direction of the first rail and the second rail is increased.

(5) In the in-vehicle device attachment structure of any one of (2) to (4), a configuration is also possible in which the intermediate base plate is longer than a distance between the first rail and the second rail in a direction in which the first rail and the second rail are arranged side by side. With this configuration, the degree of freedom in the attachment position of the retrofit device in the direction in which the first rail and the second rail are arranged side by side is increased.

(6) In the in-vehicle device attachment structure of any one of (2) to (5), a configuration is also possible in which the first rail and the second rail are arranged side by side in a width direction of the vehicle and extend in a front-rear direction of the vehicle. With this configuration, the intermediate base plate can be supported by the first rail and the second rail such that the main surface of the intermediate base plate extends in the horizontal direction.

(7) In the in-vehicle device attachment structure of any one of (1) to (6), a configuration is also possible in which an attachment member that attaches the intermediate base plate to the retrofit device attachment portion in an orientation in which attachment/removal can be performed in a horizontal direction. With this configuration, attachment/removal of the attachment member can be performed in the horizontal direction.

(8) In the in-vehicle device attachment structure of any one of (1) to (7), a configuration is also possible in which the intermediate base plate includes a base plate body and a plurality of device attachment portions provided in the base plate body, and the retrofit device is attached to a device attachment portion among the plurality of device attachment portions. With this configuration, the degree of freedom in the attachment position of the retrofit device with respect to the intermediate base plate is increased.

(9) In the in-vehicle device attachment structure of any one of (1) to (8), a configuration is also possible in which the retrofit device attachment portions are provided to a roof of the vehicle. With this configuration, the device can be easily retrofitted to the roof.

### Details of Embodiments of Present Disclosure

Specific examples of an in-vehicle device attachment structure according to the present disclosure will be described below with reference to the drawings. Note that the present disclosure is not limited to these examples, but rather is indicated by the scope of the claims, and is intended to include all modifications within the scope and meaning equivalent to the scope of the claims.

### First Embodiment

Hereinafter, an in-vehicle device attachment structure according to a first embodiment will be described.

### Vehicle to Which In-Vehicle Device Attachment Structure is to be Mounted

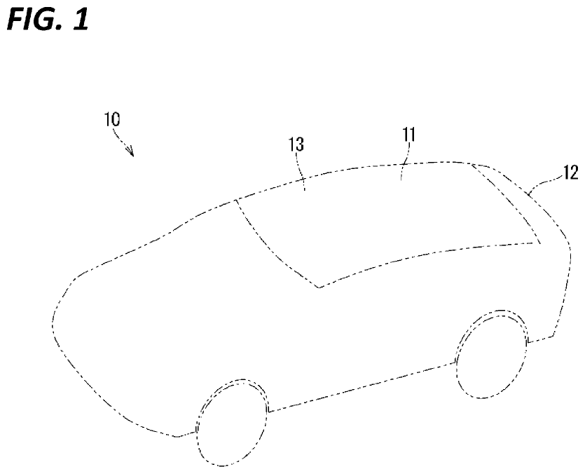

FIG. 1 is a schematic perspective view showing an example of a vehicle 10 to which an in-vehicle device attachment structure is to be mounted. The vehicle 10 includes a body 12. The body 12 is a portion that forms an outer shape of the vehicle 10. The body 12 may be a monocoque body or a body to be mounted on a ladder frame. Here, the body 12 includes side panels surrounding a vehicle interior, and a roof panel 13, and further includes a boarding door panel used when the occupants get on/off the vehicle 10, a rear door panel for loading/unloading baggage, and the like. A plate-shaped portion of the body 12 that covers the upper portion of the vehicle interior is the roof panel 13. That is, the roof panel 13 forms a roof portion 11 of the vehicle 10. The roof panel 13 may be partly or wholly curved so as to form the outer appearance shape of the body 12. The roof panel 13 may be made of a metal or a resin. The roof panel 13 may also be formed by a combination of metal and resin.

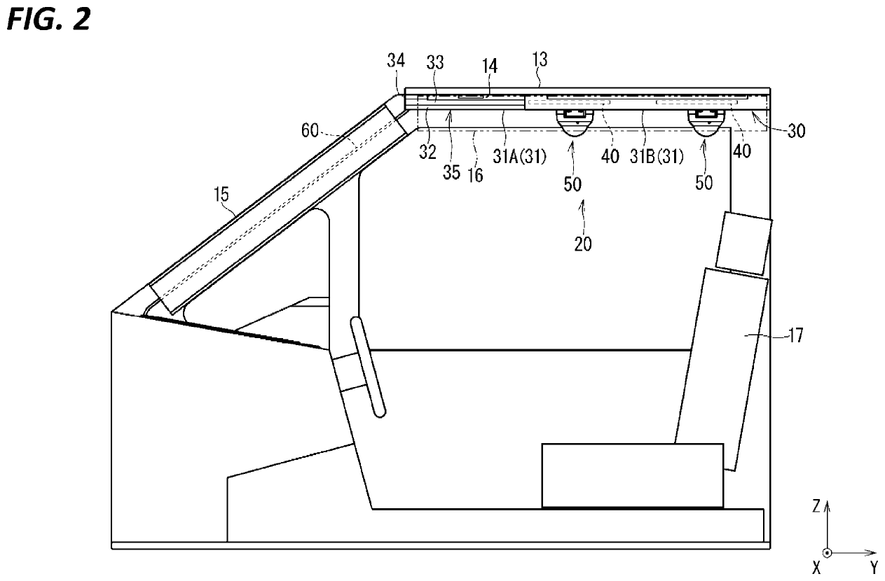

FIG. 2 is a diagram showing a position at which the in-vehicle device attachment structure 20 is mounted in the vehicle 10. FIG. 2 is a schematic view showing the vehicle 10 as observed from a lateral side. FIG. 2 shows the X direction, the Y direction, and the Z direction that are orthogonal to each other. In the present disclosure, the X direction refers to the width direction of the vehicle 10, the Y direction refers to the front-rear direction of the vehicle 10, and the Z direction refers to the vertical direction.

The in-vehicle device attachment structure 20 is disposed in an arrangement space between the body 12 that forms the outer appearance and the interior member 16 that forms the inner appearance of the vehicle 10. The interior member 16 is a plate-shaped member formed by a resin or the like. The interior member 16 is a portion exposed to the vehicle interior. The interior member 16 may be partly or wholly curved.

If retrofit devices 50 of the in-vehicle device attachment structure 20 need to be exposed to the vehicle interior in order to perform their function, insertion holes into which the retrofit devices 50 pass may be formed in the interior member 16 at positions corresponding to the retrofit devices 50. In the in-vehicle device attachment structure 20, portions other than devices that need to be exposed to the vehicle interior are covered by the interior member 16 in the vehicle interior.

In the present embodiment, an example is described in which the in-vehicle device attachment structure 20 is mounted in the roof portion 11 including the roof panel 13. The interior member 16 of the roof portion 11 is attached on the lower side of the roof panel 13. The interior member 16 of the roof portion 11 is a portion that forms the shape of the ceiling in the vehicle interior. The interior member 16 of the roof portion 11 may also be referred to as a roof liner 16.

### In-Vehicle Device Attachment Structure

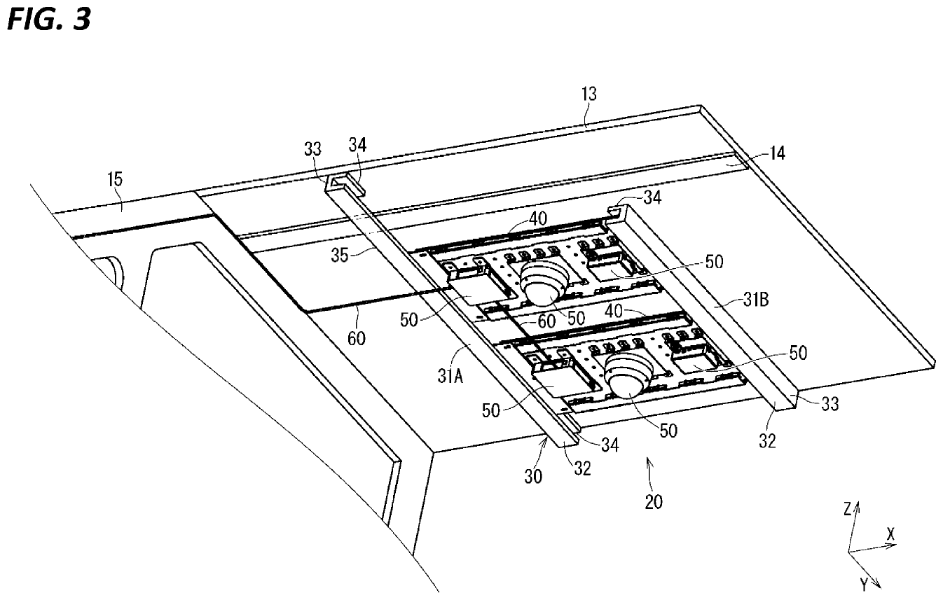

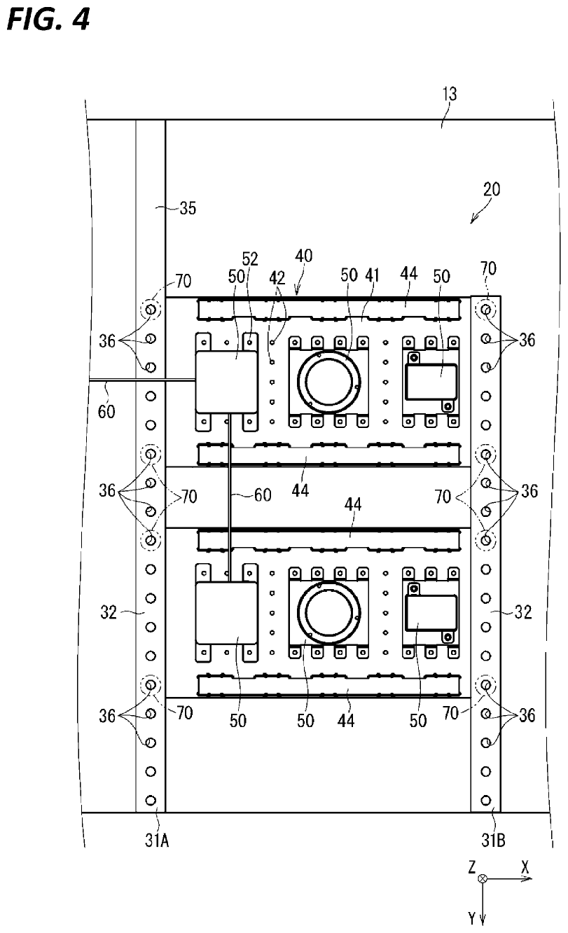

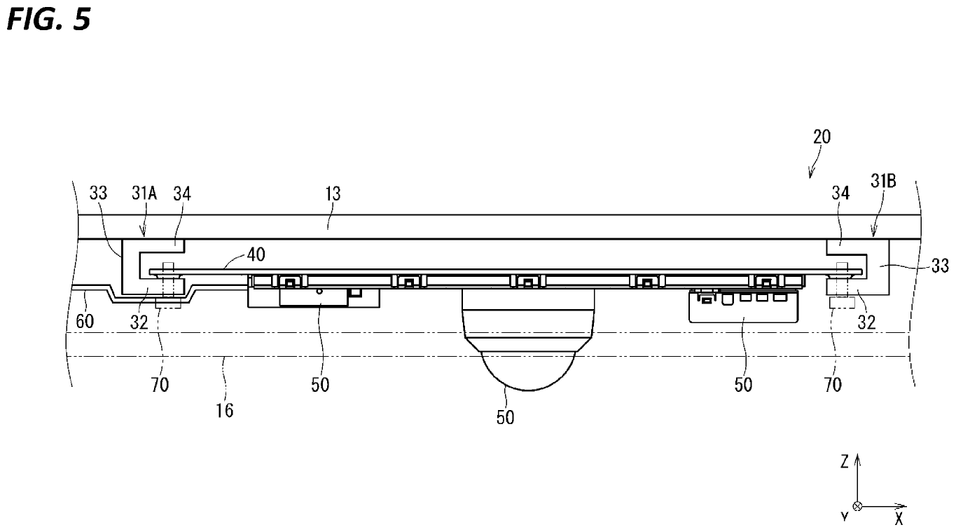

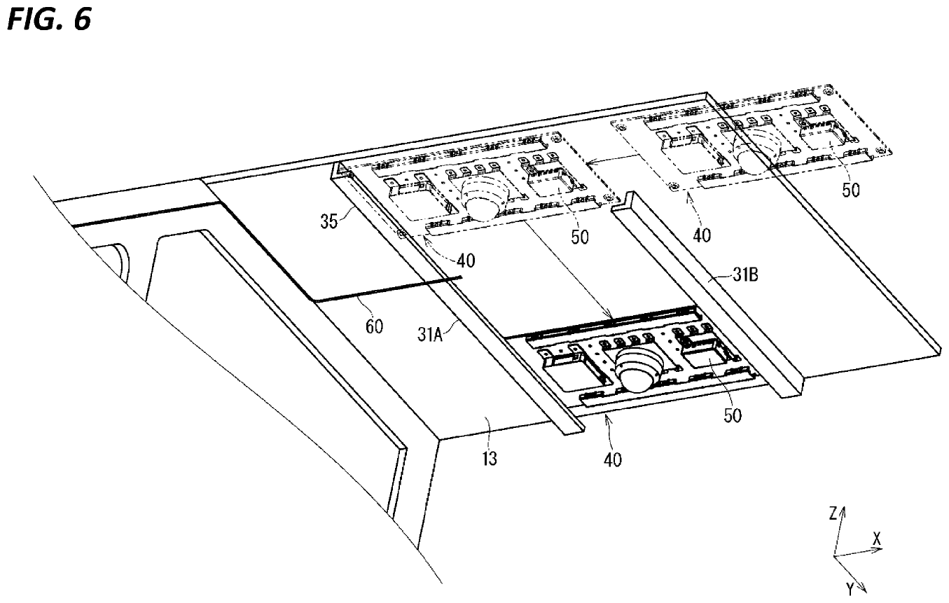

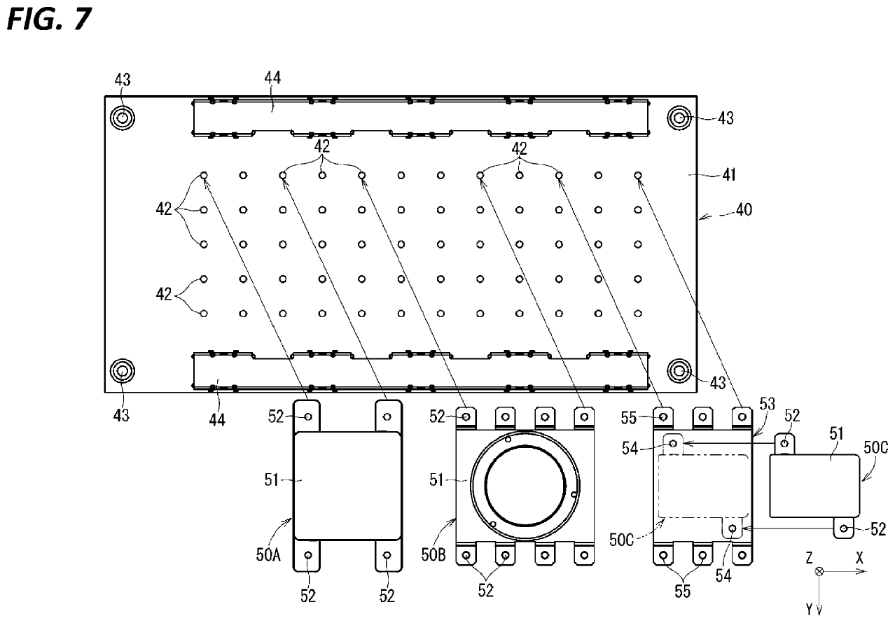

FIG. 3 is a schematic perspective view showing the in-vehicle device attachment structure 20 according to the first embodiment. FIG. 4 is a schematic bottom view showing the in-vehicle device attachment structure 20 according to the first embodiment. FIG. 5 is a schematic front view showing the in-vehicle device attachment structure 20 according to the first embodiment. FIG. 6 is an exploded perspective view of the in-vehicle device attachment structure 20. FIG. 7 is an exploded bottom view of an intermediate base plate 40 and retrofit devices 50.

The in-vehicle device attachment structure 20 includes a retrofit device attachment portion 30, the intermediate base plates 40, and the retrofit devices 50. The retrofit device attachment portion 30 is provided in the vehicle 10. The intermediate base plates 40 are attached to the retrofit device attachment portion 30. The retrofit devices 50 are respectively attached to the intermediate base plates 40. The retrofit devices 50 are each attached to the retrofit device attachment portion 30 via the intermediate base plate 40. The in-vehicle device attachment structure 20 further includes attachment members 70. The attachment members 70 attach the intermediate base plate 40 to the retrofit device attachment portion 30. Here, the attachment members 70 are screws 70. The attachment members 70 may also be clamps (clips) or the like.

When the in-vehicle device attachment structure 20 is embedded in the roof portion 11 that includes the roof panel 13, the retrofit device attachment portion 30 is arranged in a space inside the roof between the roof panel 13 and the roof liner 16. The retrofit device attachment portion 30 is provided to the roof panel 13. The retrofit device attachment portion 30 may also be provided at a location other than the roof panel 13 in the space inside the roof.

The retrofit device attachment portion 30 slidably supports the intermediate base plates 40. The retrofit device attachment portion 30 includes at least one rail 31. Each rail 31 includes a supporting portion 32 and a coupling portion 33. The supporting portion 32 supports the intermediate base plates 40. The supporting portion 32 is provided spaced apart from the roof panel 13. Each coupling portion 33 extends from the supporting portions 32 toward the roof panel 13. The leading end portion of each coupling portion 33 is fixed to the roof panel 13. For example, the leading end portion of each coupling portion 33 is provided with a body fixing portion 34 at one end portion and the other end portion of the rail 31. The body fixing portions 34 planarly extend along the roof panel 13. The body fixing portions 34 are welded to the inner surface of the roof panel 13, and the rail 31 is fixed to the roof panel 13.

In the vehicle 10, a reinforcing member 14 (also referred to as a roof reinforcement, a roof stay, or the like) may be provided to an inner surface (downward surface) of the roof panel 13 so as to extend across the roof panel 13. The rail 31 may or may not intersect the reinforcing member 14. In any case, each body fixing portion 34 is preferably fixed to the roof panel 13 at a position that avoids the reinforcing member 14. If the rail 31 intersects the reinforcing member 14, the supporting portion 32 may be located downward of the reinforcing member 14. For example, a hole into which the reinforcing member 14 is inserted may be formed in a portion of each coupling portion 33 located between the body fixing portions 34.

The intermediate base plates 40 may be supported from a lateral side of the rails 31. The intermediate base plates 40 are inserted between the supporting portions 32 and the roof panel 13 from the lateral side of the rails 31 and supported by the supporting portions 32. The intermediate base plates 40 are slidable along the extending direction of the rails 31 after being supported by the rail 31.

The retrofit device attachment portion 30 includes two rails 31. One of the two rails 31 is a first rail 31A and the other is a second rail 31B. The first rail 31A supports one lateral side of the intermediate base plate 40. The second rail 31B supports the other lateral side of the intermediate base plate 40. The first rail 31A and the second rail 31B are fixed to the roof panel 13 in an orientation with the supporting portions 32 of the first rail 31A and the second rail 31B respectively facing the second rail 31B and the first rail 31A.

The first rail 31A and the second rail 31B are arranged side by side in the width direction of the vehicle 10. The first rail 31A and the second rail 31B extend in the front-rear direction of the vehicle 10. The interval dimension between the first rail 31A and the second rail 31B and the length dimensions of the first rail 31A and the second rail 31B can be set as appropriate within a range of dimension in which the first rail 31A and the second rail 31B can be disposed on the vehicle 10. The interval between the first rail 31A and the second rail 31B along the width direction of the vehicle 10 is, for example, less than or equal to the width dimension of the roof panel 13 along the width direction of the vehicle 10. The length dimension of the first rail 31A and the second rail 31B along the front-rear direction of the vehicle 10 is, for example, less than or equal to the length dimension of the roof panel 13 along the front-rear direction of the vehicle 10.

If a plurality of rows of seats 17 in the front-rear direction are provided in the vehicle 10, a pair of the first rail 31A and the second rail 31B may be provided only at a position corresponding to a seat 17 in any one of the rows. A plurality of pairs of the first rail 31A and the second rail 31B may be provided such that a pair of the first rail 31A and the second rail 31B is provided separately to each of the plurality of rows of seats 17. A pair of the first rail 31A and the second rail 31B may also be provided in a range that spans the plurality of rows of seats 17.

The first rail 31A is longer than the second rail 31B. This is because the first rail 31A includes a protruding portion 35 that extends beyond the second rail 31B in the longitudinal direction. The length dimension of the protruding portion 35 is, for example, a length dimension with which each intermediate base plate 40 can be in a temporary supported state due to the protruding portion 35. Here, the “temporary supported state” means a state in which, with one portion of the intermediate base plate 40 supported by the protruding portion 35, an operator can slide the intermediate base plate 40 along the first rail 31A while supporting another portion of the intermediate base plate 40 by the protruding portion 35. The intermediate base plate 40 is slid from the temporary supported state and the other portion of the intermediate base plate 40 is supported by the second rail 31B. For example, the length dimension of the protruding portion 35 may be a length that is at least one quarter the length dimension of the intermediate base plate 40 along the longitudinal direction of the first rail 31A or a length that is at least half the length dimension thereof. Also, for example, the length dimension of the protruding portion 35 may be longer than or equal to the length dimension of the intermediate base plate 40 along the longitudinal direction of the first rail 31A.

The retrofit device attachment portion 30 includes base plate attachment portions 36. In this example, base plate attachment holes 36 are provided as the base plate attachment portions 36. The base plate attachment holes 36 are provided in the first rail 31A and the second rail 31B. In this example, the base plate attachment holes 36 are formed in the supporting portions 32. The base plate attachment holes 36 extend through the rails 31 in the vertical direction.

A plurality of the base plate attachment holes 36 are formed in the first rail 31A. A plurality of the base plate attachment holes 36 are also formed in the second rail 31B. The plurality of base plate attachment holes 36 are provided spaced apart from each other along the longitudinal direction of the first rail 31A and the second rail 31B. The intermediate base plates 40 are attached to any of the plurality of base plate attachment holes 36.

The intermediate base plates 40 each include a base plate body 41. Each base plate body 41 is made of a metal or a resin. The base plate bodies 41 are rigid members that can support the retrofit devices 50 in a suspended manner and support the retrofit devices 50. The base plate bodies 41 have a rectangular plate shape. In this example, the length dimension of the base plate bodies 41 in the width direction of the vehicle 10 is longer than that in the front-rear direction of the vehicle 10. The length dimension of the base plate bodies 41 in the front-rear direction of the vehicle 10 may be longer than that in the width direction of the vehicle 10. The base plate bodies 41 may also have a square plate shape having the same length in the width direction and the front-rear direction of the vehicle 10.

Each retrofit device 50 is attached to a downward surface of the base plate body 41. Each retrofit device 50 may also be attached to an upward surface of the base plate body 41. The downward surface and the upward surface of each base plate body 41 are flat surfaces. A reinforcing rib for improving the rigidity of the base plate body 41 may be formed on at least one of the downward surface and the upward surface of each base plate body 41. For example, a configuration is also possible in which a portion of a device attachment surface (here, the downward surface) other than the openings of device attachment holes 42 is a flat surface and a reinforcing rib is formed on the opposite surface to the device attachment surface (here, the upward surface). A plurality of reinforcing ribs may be formed. For example, as the plurality of reinforcing ribs, reinforcing ribs extending in the X direction and reinforcing ribs extending in the Y direction may be disposed in a lattice shape. The device attachment holes 42 may be formed in a portion surrounded by the reinforcing ribs.

The screw holes 43 that serve as the attachment portions of the attachment members 70 are formed in each intermediate base plate 40. By the screws 70 being screwed to the base plate attachment holes 36 and the screw holes 43, the intermediate base plate 40 is fixed to the rails 31. The screw holes 43 are formed in four corners of the base plate body 41, for example. The interval between the two screw holes 43 arranged side by side in the width direction of the vehicle 10 is the same as the interval between the base plate attachment holes 36 of the first rail 31A and the base plate attachment holes 36 of the second rail 31B. The interval between the two screw holes 43 arranged side by side in the front-rear direction of the vehicle 10 is an integral multiple of the interval of the base plate attachment holes 36 that are adjacent to each other in the rails 31.

Each intermediate base plate 40 includes the device attachment portions 42. In this example, the device attachment holes 42 are provided as the device attachment portions 42. The device attachment holes 42 are formed in the base plate body 41. The device attachment holes 42 extend through the base plate body 41 in the vertical direction. A plurality of the device attachment holes 42 are formed in the base plate body 41. The plurality of device attachment holes 42 are distributed like grid points with respect to the base plate body 41. The retrofit devices 50 are attached to any of the plurality of device attachment holes 42.

The retrofit devices 50 are not particularly limited and can be set as appropriate. For example, the retrofit devices 50 may be biological authentication devices. Alternatively, the retrofit devices 50 may be cameras for shooting images of the vehicle interior. In this case, holes through which the cameras are passed through are formed in the interior member 16. In a case where the biological authentication device adopts a face authentication system, the camera may shoot images of the faces of occupants. Also, for example, the retrofit devices 50 may be speakers, monitors, or the like. Further, for example, the retrofit devices 50 may be devices that are developed later than the vehicle 10.

A plurality of screw holes 52 are formed in casings 51 of retrofit devices 50A and 50B. The plurality of screw holes 52 are formed at intervals corresponding to the device attachment holes 42. By the screws being fastened to the screw holes 52 and the device attachment holes 42, the retrofit devices 50 are fixed to the intermediate base plates 40.

The retrofit devices 50 are each attached to any of the plurality of device attachment holes 42, and the intermediate base plate is attached to any of the plurality of base plate attachment holes 36. In this manner, in the width direction and the front-rear direction of the vehicle 10, the number of positions that can be selected as the attachment positions of the retrofit devices 50 are increased. As a result, the retrofit devices 50 can be easily attached to appropriate attachment positions in the vehicle 10.

A retrofit device 50C is attached to the base plate body 41 via a bracket 53. Screw holes 54 that correspond to a retrofit device 50C and screw holes 55 that correspond to the device attachment holes 42 are formed in the bracket 53. By the screws being fastened to the screw holes 52 provided in the casing 51 of the retrofit device 50C and the screw holes 54 of the bracket 53, the retrofit device 50C is fixed to the bracket 53. Also, by the screws being fastened to the device attachment holes 42 and the screw holes 55 of the bracket 53, the bracket 53 is fixed to the intermediate base plate 40. In this manner, even if the screw holes 52 provided in the casing 51 of the retrofit device 50C do not correspond to the device attachment holes 42, the retrofit device 50C can be attached to the intermediate base plate 40 via the bracket 53.

A transmission member 60 is connected to the retrofit devices 50. The transmission member 60 is a member for transmitting electricity, light, or the like, and a member provided along a wiring path, with at least one end portion thereof being connected to the retrofit devices 50. For example, the transmission member 60 may be a general electric wire including a core wire and a coating in the periphery of the core wire, a bare conductor, a shield wire, an electric cable, an enamel wire, a nichrome wire, a coaxial cable, an optical fiber, or the like. In other words, the transmission members 60 may be wire-shaped members that transmit electricity. Examples of wire-shaped members that transmit electricity include various signal lines and electric power lines. Examples of the wire-shaped transmission member 60 that transmits electricity also include a single wire-shaped member, and a composite wire formed by a plurality of wire-shaped members (a twisted wire, a cable formed by collecting a plurality of wire-shaped members and covering the wire-shaped members with a sheath). The transmission member 60 may be formed by applying conductive paint on a sheet-shaped member, or etching on a copper foil. The following description will be given on the assumption that the transmission member 60 is a general electric wire.

One end portion of the transmission member 60 and each retrofit device 50 may be connected to each other via a connector. The transmission member 60 may be directly introduced into the retrofit device 50 and directly connected to electric elements inside the retrofit device 50. The other end portion of the transmission member 60 extends toward a device (e.g., an electronic control unit or a power supply) other than the retrofit device 50. A portion of the transmission member 60 that extends out from the retrofit device 50 is held by the intermediate base plate 40. A portion of each transmission member 60 on the other end portion side relative to the portion held by the intermediate base plate 40 may be drawn out to the pillar 15 or the like, and connected to a device downward of the roof portion 11 of the vehicle 10. In the example shown in FIG. 2, a single transmission member 60 extends along the pillar 15, but a plurality of transmission members 60 may be provided.

If retrofit devices 50 are added, transmission members 60 may also be added. A device for supplying power and relaying signals may be disposed in the space inside the roof, and a transmission member 60 of the retrofit devices 50 may be connected to the device. The transmission member 60 of the retrofit devices 50 may be extended to the outside of the space inside the roof.

Each intermediate base plate 40 includes transmission member holding portions 44. The transmission member holding portions 44 hold the transmission member 60. The transmission member holding portions 44 are formed into a gutter shape having a bottom portion and side wall portions, for example. An opening of each transmission member holding portion 44 is closed by the base plate body 41 and a path through which the transmission member 60 passes is formed between the transmission member holding portion 44 and the base plate body 41. An opening portion through which the transmission member 60 passes may be formed in the side wall portions. The transmission member holding portions 44 are provided at both side edge portions of the base plate body 41. The transmission member holding portion 44 may be provided at only one side edge portion of the base plate body 41.

The transmission member holding portions 44 are removably attached to the base plate bodies 41. For example, each base plate body 41 has a lock portion and each transmission member holding portion 44 has a partner lock portion. The lock portion and the partner lock portion are removably locked to each other.

A portion of the transmission member 60 that extends from the intermediate base plate 40 toward the pillar 15 may be supported by the interior member 16 or the roof panel 13.

In this example, the plurality of intermediate base plates 40 are supported by a pair of rails 31. Only one intermediate base plate 40 may be supported by the pair of rails 31. The transmission member 60 extending along the pillar 15 is connected to a retrofit device 50 of a first intermediate base plate 40. Then, another retrofit device 50 of a second intermediate base plate 40 is connected to the retrofit device 50 of the first intermediate base plate 40 via another transmission member 60.

### Method for Retrofitting Retrofit Device 50

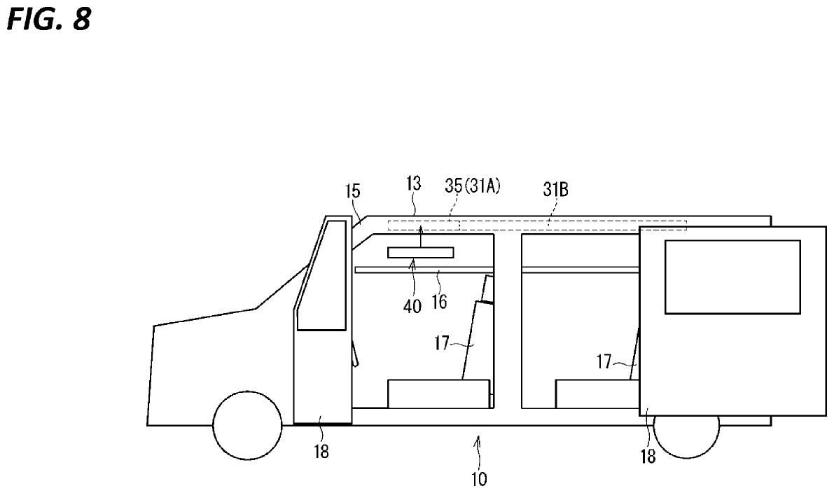

A method for retrofitting a retrofit device 50 will be described below with reference to FIG. 8 in addition to FIGS. 1 to 7. FIG. 8 is a diagram showing a method for retrofitting the retrofit device 50.

The method for retrofitting the retrofit device 50 is a method for retrofitting the retrofit device 50 after completion of production of the vehicle 10. The rails 31 are provided to the vehicle 10 in advance. The rails 31 may or may not be provided with an intermediate base plate 40 and devices that have been attached prior to the retrofit device 50.

In the state where the vehicle 10 is usually used, the rails 31 are concealed between the body 12 and the interior member 16. In a case where the retrofit device 50 is retrofitted after completion of the vehicle 10, first, the interior member 16 needs to be partly or wholly removed to expose the rails 31. For example, in a case where the retrofit device 50 is to be retrofitted on the roof, as shown in FIG. 8, the roof liner 16 is lowered to be supported on the seat back of the seat 17. In this state, the work for retrofitting the retrofit device 50 to the rails 31 is performed through a gap between the roof liner 16 and the roof panel 13.

The work for retrofitting the retrofit device 50 to the rails 31 includes attaching an intermediate base plate 40 (hereinafter referred to as a “retrofit device-equipped base plate”) to which the retrofit device 50 to be newly attached) to be supported by the rails 31. Specifically, first, the operator inserts the retrofit device-equipped base plate into the vehicle interior from one lateral side through a gap between the roof liner 16 and the roof panel 13. Next, the operator places the one lateral side of the retrofit device-equipped base plate so as to be supported by the protruding portion 35 of the first rail 31A, while supporting the other lateral side of the retrofit device-equipped base plate. At this time, if the work for supporting the intermediate base plate 40 can be performed from the lateral side with respect to the rails 31, the direction in which the retrofit device-equipped base plate is moved into the vehicle interior and the direction in which the retrofit device-equipped base plate is moved to be supported by the rails 31 coincide, and thus the work for retrofitting is facilitated. Next, the operator slides the retrofit device-equipped base plate along the first rail 31A to the attachment position while the second rail 31B also supports the retrofit device-equipped base plate. Next, the operator fastens the screws 70 to the base plate attachment holes 36 and the screw holes 43 to fix the retrofit device-equipped base plate to the rails 31.

In the state immediately after the interior member 16 is removed, the attachment position of the retrofit device-equipped base plate may or may not be vacant. When the attachment position of the retrofit device-equipped base plate is vacant, the retrofit device-equipped base plate is immediately attached to a predetermined attachment position after the interior member 16 is removed. When the attachment position of the retrofit device-equipped base plate is not vacant, after making the attachment position of the retrofit device-equipped base plate vacant, the retrofit device-equipped base plate is attached to a predetermined attachment position. At any stage between the state where the retrofit device-equipped base plate is outside of the vehicle interior and the state where the retrofit device-equipped base plate is fixed to a predetermined attachment position, the transmission member 60 may be connected to the retrofit device 50 on the retrofit device-equipped base plate.

A case where the attachment position of the retrofit device-equipped base plate is vacant is conceivably a case where the intermediate base plate 40 (hereinafter referred to as a “pre-fitted device-equipped base plate”) is not attached to the rails 31 that appear when the interior member 16 is removed. In addition to this, includes a case where, even if the pre-fitted device-equipped base plate has been already attached to the rails 31 that appear when the interior member 16 is removed, the attachment position of the retrofit device-equipped base plate does not overlap the attachment position of the pre-fitted device-equipped base plate, is interpreted as a case where the attachment position of the retrofit device-equipped base plate is vacant. In this case, the retrofit device-equipped base plate is attached to the rails 31 side by side with the pre-fitted device-equipped base plate along the longitudinal direction of the rails 31.

A case where the attachment position of the retrofit device-equipped base plate is not vacant is conceivably a case where the attachment position of the retrofit device-equipped base plate overlaps the attachment position of the pre-fitted device-equipped base plate. In this case, the work for retrofitting further includes work for removing the pre-fitted device-equipped base plate.

When the pre-fitted device-equipped base plate is to be removed, first, the operator removes the screws 70 to release the fixed state of the pre-fitted device-equipped base plate and the rails 31. Next, the operator slides the pre-fitted device-equipped base plate from the attachment position along the first rail 31A and the second rail 31B such that the pre-fitted device-equipped base plate is supported only by the protruding portion 35 of the first rail 31A. Next, the operator removes the pre-fitted device-equipped base plate from the first rail 31A to the outside of the vehicle interior through the gap between the roof liner 16 and the roof panel 13. At this time, if the intermediate base plate 40 can be removed from the lateral side with respect to the rails 31, the direction in which the retrofit device-equipped base plate is moved to be removed from the rails 31 and the direction in which the retrofit device-equipped base plate is moved to the outside of the vehicle interior coincide, and thus the work for removing is facilitated.

When the pre-fitted device-equipped base plate is removed, a new retrofit device 50 may be attached to the removed pre-fitted device-equipped base plate to form a retrofit device-equipped base plate, and the retrofit device-equipped base plate thus formed may be attached to the vehicle 10 again. Alternatively, a method is also possible in which the retrofit device-equipped base plate is prepared in advance separately from the pre-fitted device base plate, and the retrofit device-equipped base plate is attached to the vehicle 10 instead of the pre-fitted device-equipped base plate.

### Effects, Etc.

According to the in-vehicle device attachment structure 20 with the above configuration, the retrofit devices 50 are attached to the vehicle 10 via the intermediate base plates 40. Due to the attachment structures of the intermediate base plates 40 and the retrofit device attachment portion 30 being standardized, and an attachment structure that conforms to the retrofit devices 50 being adopted for the intermediate base plates 40, there is no need to provide the attachment structure corresponding to various kinds of retrofit devices 50 to the vehicle 10, and various types of devices can be easily retrofitted to the vehicle 10.

Further, a new attachment structure that is not compliant with the standard of the conventional vehicle 10, for example, may be adopted to a later-developed device that is developed after completion of the vehicle 10. In this case as well, the intermediate base plates 40 can be adopted to the new attachment structure of the later-developed device, and the conventional attachment structure of the vehicle 10 can be used as the attachment structure of the intermediate base plates 40 and the retrofit device attachment portion 30. As a result, the later-developed device with the new attachment structure can also be easily retrofitted to the conventional vehicle 10.

Also, in the case where a device is attached to the roof, for example, conventionally, an attachment bracket dedicated for the device is disposed on the roof. For this reason, the position of the device and the type of the device cannot be changed. In view of this, in the present disclosure, the retrofit device attachment portion 30 is provided to the roof of the vehicle 10. In this manner, the device can be easily retrofitted to the roof.

Also, the retrofit device attachment portion 30 includes the first rail 31A that supports the one lateral side of the intermediate base plates 40 and the second rail 31B that supports the other lateral side of the intermediate base plates 40. In this manner, the intermediate base plates 40 can slide to the attachment positions along the first rail 31A and the second rail 31B.

Also, the first rail 31A is longer than the second rail 31B. Accordingly, when the intermediate base plates 40 are supported by the first rail 31A and the second rail 31B, the intermediate base plates 40 slide while one lateral side of each intermediate base plates 40 is supported by the protruding portion 35 of the first rail 31A that extends beyond the second rail 31B, and the other lateral side of each intermediate base plate 40 can be supported by the second rail 31B. In this manner, the work for placing the intermediate base plates 40 so as to be supported by the first rail 31A and the second rail 31B can be easily performed.

Also, the retrofit device attachment portion 30 includes the plurality of base plate attachment portions 36 provided at the plurality of positions spaced apart from each other along the longitudinal direction of the first rail 31A and the second rail 31B, and each intermediate base plate 40 is attached to any of the plurality of base plate attachment portions 36. In this manner, the degree of freedom in the attachment position of the intermediate base plates 40 in the longitudinal direction of the first rail 31A and the second rail 31B is increased. Accordingly, the degree of freedom in the attachment position of the retrofit devices 50 in the vehicle 10 is increased.

The first rail 31A and the second rail 31B are arranged side by side in the width direction of the vehicle 10, and extend in the front-rear direction of the vehicle 10. In this manner, the intermediate base plates 40 can be supported by the first rail 31A and the second rail 31B in such a way that the main surfaces of the intermediate base plates 40 extend in the horizontal direction.

Also, the intermediate base plates 40 each include the base plate body 41 and the plurality of device attachment portions 42 provided to the base plate body 41, and each retrofit device 50 is attached to any of the plurality of device attachment portions 42. Accordingly, the degree of freedom in the attachment positions of the retrofit devices 50 to the intermediate base plates 40 is increased.

### Second Embodiment

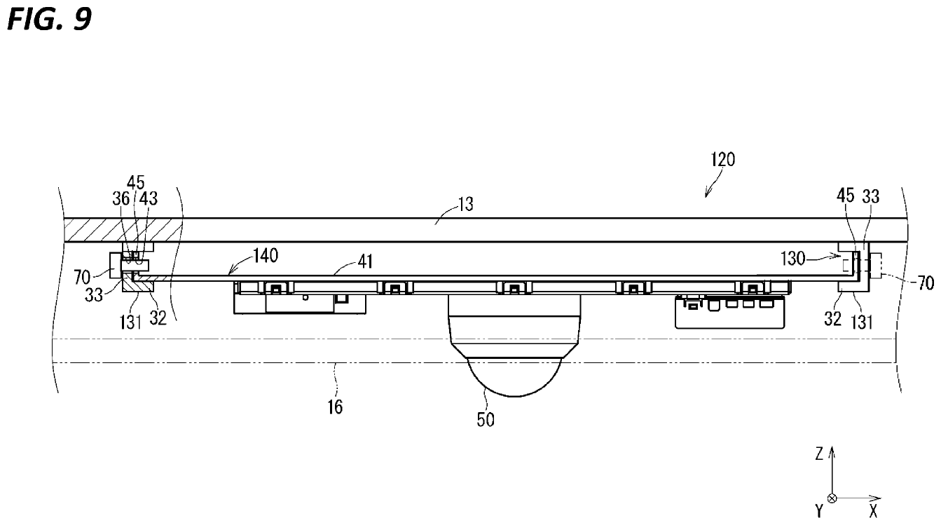

An in-vehicle device attachment structure according to a second embodiment will be described. FIG. 9 is a schematic front view showing an in-vehicle device attachment structure 120 according to the second embodiment. In FIG. 9, a portion is shown in a cross-sectional view. Note that, in the following description, the constitutional elements similar to those described before are denoted by the same reference numerals, and the descriptions thereof are omitted.

In the in-vehicle device attachment structure 120, the orientation of the attachment members 70 is different from the orientation of the attachment members 70 in the in-vehicle device attachment structure 20. In the in-vehicle device attachment structure 120, the attachment members 70 attach each intermediate base plate 140 to the retrofit device attachment portion 130 in the orientation in which attachment/removal can be performed in the horizontal direction. In this manner, the attachment/removal of the attachment members 70 can be performed in the horizontal direction.

In the case where the retrofit device attachment portion 130 is provided to the roof, if the base plate attachment holes 36 extend through the rails 31 in the vertical direction, the attachment/removal of the attachment members 70 can be performed in the vertical direction. In this case, the attachment/removal of the attachment members 70 may involve overhead work. Generally, such overhead work is bothersome, and in particular, when performing attachment/removal of the attachment members 70 in a narrow space between the roof panel 13 and the interior member 16 that has been removed from the roof panel 13 and placed on a seat back of the seat 17 as shown in FIG. 8, the overhead work may be more bothersome. Contrary to this, if the intermediate base plates 140 are attached to the retrofit device attachment portion 130 in the orientation in which attachment/removal of the attachment members 70 can be performed in the horizontal direction, since the attachment/removal of the attachment members 70 can be performed in the horizontal direction, no overhead work is required when attaching/removing the attachment members 70.

It is preferable that the attachment members 70 attach the intermediate base plates 140 to the retrofit device attachment portion 130 in the orientation in which attachment/removal of the intermediate base plates 140 can be performed in the horizontal width direction of the vehicle 10. In this manner, when the operator attaches/removes the intermediate base plates 140 to/from the retrofit device attachment portion 130 via the opening of the door 18 in the state where the side door 18 of the vehicle 10 for occupants is open, it is easy to access receiving parts of the attachment members 70. Here, the base plate attachment holes 36 extend, in the X direction, through the rails 131 that extend in the Y direction. The base plate attachment holes 36 extend through the coupling portions 33 of the rails 131. In this manner, the attachment members 70 attach the intermediate base plates 140 to the retrofit device attachment portion 130 in the orientation in which attachment/removal of the intermediate base plates 140 can be performed in the horizontal width direction of the vehicle 10.

The rails 131 may be provided inward of the side edge portion of the roof panel 13. The interval between the side edge portions of the roof panel 13 and the rails 131 may be more than or equal to the length dimension of the attachment members 70, for example. In this manner, the space for performing attachment/removal of the attachment members 70 in the width direction of the vehicle 10 can be easily ensured.

The screw holes 43 of the intermediate base plates 140 extend through the intermediate base plates 140 in the X direction so as to conform to the base plate attachment holes 36 of the rails 131. The intermediate base plates 140 each include ribs 45 provided on both sides of each base plate body 41. The ribs 45 extend in the vertical direction from the respective end edge portions of the base plate body 41. The screw holes 43 are respectively formed in the ribs 45. The length dimension of the ribs 45 in the Y direction may be the same as the length dimension of the base plate body 41. The length dimension of the ribs 45 in the Y direction may be shorter than the length dimension of the base plate body 41. The plurality of ribs 45 that are shorter than the base plate body 41 in the Y direction may be provided spaced apart from each other in the Y direction. Openings may be formed between the ribs 45 arranged side by side in the Y direction. The base plate bodies 41 and the ribs 45 may be formed by bending a single metal plate. Each base plate body 41 and the ribs 45 may be formed separately and then fixed to each other through screwing, welding, or the like.

### Third Embodiment

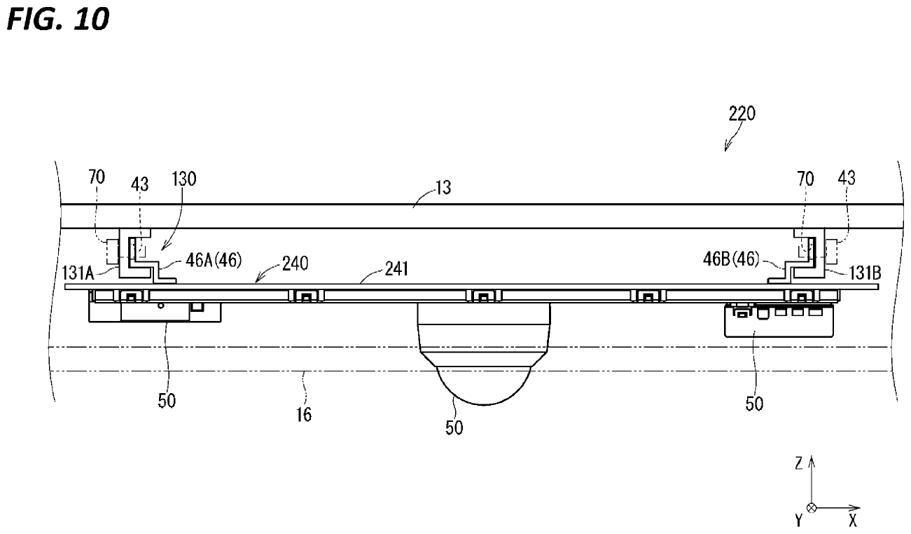

The in-vehicle device attachment structure according to a third embodiment will be described. FIG. 10 is a schematic front view showing an in-vehicle device attachment structure 220 according to the third embodiment.

In the in-vehicle device attachment structure 20 of the first embodiment, the intermediate base plates 40 are accommodated between the first rail 31A and the second rail 31B, but this is not an essential configuration. A configuration is also possible in which, as in the in-vehicle device attachment structure 220 in this example, in the direction in which the first rail 131A and the second rail 131B are arranged side by side, the length dimension of the intermediate base plates 240 (the length dimension of the base plate bodies 241) may be longer than the interval between the first rail 131A and the second rail 131B. In this manner, in the direction in which the first rail 131A and the second rail 131B are arranged side by side, the degree of freedom in the attachment positions of the retrofit devices 50 is increased. For example, this makes it possible to dispose the retrofit devices 50 below the rails 131 or outward in the width direction of the vehicle of the rails 131.

Each intermediate base plate 240 includes a plurality of brackets 46. The brackets 46 extend from the base plate body 241. One end portion of each bracket 46 is coupled to the base plate body 241. The other end portion of each bracket 46 is supported by the rail 131. The base plate body 241 and the brackets 46 may be formed by bending a single metal plate. The base plate body 241 and the brackets 46 may be formed separately and then fixed to each other through screwing, welding, or the like. Of the plurality of brackets 46, the first bracket 46A is movably supported by the first rail 131A, and the second bracket 46B is movably supported by the second rail 131B.

Each intermediate base plate 240 may be configured such that the length of the portion that protrudes toward the first rail 131A and the length of the portion that protrudes toward the second rail 131B can be adjusted. For example, in each base plate body 241, the attachment positions of the brackets 46 may be changeable. In the base plate body 241, a plurality of the screw holes for the brackets 46 may be formed, and the brackets 46 may be fixed to any of the plurality of screw holes for the brackets 46.

In this example as well, similar to the in-vehicle device attachment structure 120 according to the second embodiment, the attachment members 70 attach the intermediate base plates 240 to the retrofit device attachment portion 130 in the orientation in which attachment/removal can be performed in the horizontal direction. In the intermediate base plates 240, the screw holes 43 are formed so as to extend through the brackets 46 in the X direction.

### Supplementary Note

In the above description, the retrofit device attachment portion 30 includes the first rail 31A that supports one lateral side of the intermediate base plates 40 and the second rail 31B that supports the other lateral side of the intermediate base plates 40, but this is not an essential configuration. For example, the retrofit device attachment portion 30 may include a plurality of brackets for supporting the intermediate base plates 40, instead of the rails 31. Also, for example, the retrofit device attachment portion 30 may be provided to the reinforcing member 14 or the like.

Also, in the above description, the first rail 31A is longer than the second rail 31B, but this is not an essential configuration. The first rail 31A may have the same length as the second rail 31B.

Also, in the above description, the retrofit device attachment portion 30 includes the plurality of base plate attachment portions 36 provided at the plurality of positions spaced apart from each other along the longitudinal direction of the first rail 31A and the second rail 31B, and the intermediate base plates 40 are attached to any of the plurality of base plate attachment portions 36. However, this is not an essential configuration. The base plate attachment portions 36 may be provided at only one position in the first rail 31A and the second rail 31B.

Also, in the above description, the first rail 31A and the second rail 31B are arranged side by side in the width direction of the vehicle 10 and extend in the front-rear direction of the vehicle 10, but this is not an essential configuration. For example, the first rail 31A and the second rail 31B may be arranged side by side in the front-rear direction of the vehicle 10 and extend in the width direction of the vehicle 10. In this case as well, the intermediate base plate 40 extends in the horizontal direction.

Also, in the above description, the in-vehicle device attachment structure 20 includes the attachment members 70 that attach the intermediate base plates 40 to the retrofit device attachment portion 30 in the orientation in which the attachment/removal can be performed in the horizontal direction, but this is not an essential configuration. For example, the attachment members 70 may attach the intermediate base plates 40 to the retrofit device attachment portion 30 in the orientation in which attachment/removal can be performed in the vertical direction.

Also, in the above description, each intermediate base plate 40 includes the base plate body 41 and a plurality of device attachment portions 42 provided in the base plate body 41, and each retrofit device 50 is attached to any of the plurality of device attachment portions 42, but this is not an essential configuration. For example, each intermediate base plate 40 may also include only one device attachment portion 42. It is not essential that unused device attachment portions 42 are present in each intermediate base plate 40. Each intermediate base plate 40 may be designed in a dedicated manner according to the retrofit device 50.

Further, in the above description, the retrofit device attachment portion 30 is provided to the roof, but this is not an essential configuration. The retrofit device attachment portion 30 may be provided at a location other than the roof. For example, the retrofit device attachment portion 30 may be provided to the door 18. In this manner, the retrofit devices 50 can be easily retrofitted to the door 18 via the retrofit device attachment portion 30 and the intermediate base plates 40 provided to the door 18. The retrofit device attachment portion 30 may also be provided to the door panel. The retrofit device attachment portion 30 may also be disposed in a space between the door panel and a door trim. The first rail 31A and the second rail 31B are arranged side by side in a height direction of the vehicle 10 and may extend in the front-rear direction of the vehicle 10. In this case, the intermediate base plates 40 extend in the vertical direction, and it is preferable in the case where the retrofit device attachment portion 30 is provided to the door 18 of the vehicle 10, for example.

Note that the configurations described in the above embodiments and variations may be combined as appropriate as long as no mutual contradictions arise.

### LIST OF REFERENCE NUMERALS

10 Vehicle
11 Roof portion
12 Body
13 Roof panel
14 Reinforcing member
15 Pillar
16 Roof liner (Interior member)
17 Seat
18 Door
20, 120, 220 In-vehicle device attachment structure
30, 130 Retrofit device attachment portion
31, 131 Rail
31A, 131A First rail
31B, 131B Second rail
32 Supporting portion
33 Coupling portion
34 Body fixing portion
35 Protruding portion
36 Base plate attachment hole (Base plate attachment portion)
40, 140, 240 Intermediate base plate
41, 241 Base plate body
42 Device attachment hole (Device attachment portion)
43 Screw hole (Attachment member attachment portion)
44 Transmission member holding portion
45 Rib
46 Bracket
50 Retrofit device
51 Casing
52 Screw hole
53 Bracket
54,55 Screw hole
60 Transmission member
70 Screw (Attachment member)

1. An in-vehicle device attachment structure comprising:
a retrofit device attachment portion provided in a vehicle:
an intermediate base plate attached to the retrofit device attachment portion; and
a retrofit device attached to the intermediate base plate.

2. The in-vehicle device attachment structure according to claim 1,
wherein the retrofit device attachment portion includes a first rail that supports one lateral side of the intermediate base plate and a second rail that supports another lateral side of the intermediate base plate.

3. The in-vehicle device attachment structure according to claim 2,
wherein the first rail is longer than the second rail.

4. The in-vehicle device attachment structure according to claim 2,
wherein the retrofit device attachment portion includes a plurality of base plate attachment portions provided at a plurality of positions spaced apart from each other along a longitudinal direction of the first rail and the second rail, and
the intermediate base plate is attached to one of the plurality of base plate attachment portions.

5. The in-vehicle device attachment structure according to claim 2,
wherein the intermediate base plate is longer than a distance between the first rail and the second rail in a direction in which the first rail and the second rail are arranged side by side.

6. The in-vehicle device attachment structure according to claim 2,
wherein the first rail and the second rail are arranged side by side in a width direction of the vehicle and extend in a front-rear direction of the vehicle.

7. The in-vehicle device attachment structure according to claim 1, further including:
an attachment member that attaches the intermediate base plate to the retrofit device attachment portion in an orientation in which attachment/removal can be performed in a horizontal direction.

8. The in-vehicle device attachment structure according to claim 1,
wherein the intermediate base plate includes a base plate body and a plurality of device attachment portions provided in the base plate body, and
the retrofit device is attached to one of the plurality of device attachment portions.

9. The in-vehicle device attachment structure according to claim 1,
wherein the retrofit device attachment portions are provided to a roof of the vehicle.
